(19) United States
(12) Patent Application Publication
(10) Pub. No.: US 2023/0059350 A1
(43) Pub. Date: Feb. 23, 2023

(54) Automatic lowering or lifting roller shutter

(71) Applicant: Ningbo Zhenfei Decorated Curtain., Ltd., Yuyao City (CN)

(72) Inventor: Jiefei Lu, Yuyao City (CN)

(21) Appl. No.: 17/979,358

(22) Filed: Nov. 2, 2022

(30) Foreign Application Priority Data
Jan. 27, 2022 (CN) 202220225842.7

(51) Int. Cl. E06B 9/60; E06B 9/42; E06B 9/78

(52) U.S. Cl. CPC E06B 9/60; E06B 9/42; E06B 9/78; E06B 2009/785

(57) ABSTRACT

The Invention relates to the field of roller shutter, discloses the automatic landing or rising type roller shutter, the main point of its technical solution is to include the shell, the shell is set with a disc, the side of the shell is set with an extension tube, the side of the disc is set with an extension body, at least part of the extension body extends into the extension tube, through the user pulling the rope body, drive the roller shutter rise or fall, in each with any start-stop structure or can advance to apply the force of the spring roller shutter. The rope body is provided with a pull rod in the part of the rope body that extends out of the shell, and the rope body is pulled by the pull rod to facilitate the user's grip and prevent the rope body from knotting and other situations.

### TECHNOLOGY FIELD

The Invention relates to the field of roller blinds, and more specifically to automatic lowering or lifting roller shutter.

### BACKGROUND OF THE INVENTION

Rolling curtain is a kind of window decoration products, is the curtain fabric by resin processing, rolled into a roller shape, using the pull cord or chain for the way to rise and fall, simple and convenient operation.

The roller shutter includes two fixed frames set opposite to each other, through which the roller shutter is fixed on the wall, and the roller shutter rod is set between the two fixed frames. Because different users have different needs for the required light at different times, so the roller shutter is required to stay at any position, and the China patent of application number 202120973189.8 proposes a spring-loaded roller shutter that can start and stop at any position, which can realize the roller shutter to stay in any position and achieve contraction.

The China patent of application number 202121033774.6, which proposes a spring-loaded shutter that can be preloaded in advance, which also enables the shutter to stay in any position and to be retracted.

In the existed roller shutter, in the process of arbitrary start and stop, you need to operate through the rope, pull down the rope and do not release, the roller shutter to rise, release the rope, you can arbitrarily stop, but when the roller shutter rises to the top, The operating rope can not put down the roller shutter, and the bottom rail of the roller shutter needs to be pulled down by hand. If the roller shutter is very high, there is a situation that the user cannot reach.

### SUMMARY OF THE INVENTION

In response to the shortcomings of the prior art, the purpose of the Invention is to provide automatic lowering or lifting roller shutter for driving the tube plug to rotate by pulling the rope body.

In order to achieve the above purpose, the Invention provides the following technical solution: automatic lowering or lifting type roller shutter, comprising a shell, said shell is provided with a disc, said shell is provided with an extension tube on one side, said disc is provided with an extension body on one side, at least part of said extension body extends into said extension tube so that said disc is coaxial with said extension tube. A groove is arranged on the side of the disc away from the extension body, and an elastic element is arranged in the groove. One end of the elastic element is fixed with the disc, and the other end of the elastic element is fixed with the shell. The disc is surrounded by a rope body, one end of the rope body is fixed with the disc, and the other end of the rope body extends out of the shell. The inner side of the shell is provided with a cylinder, the cylinder extends out of the extension pipe, and the cylinder is rotationally connected with a rotating member whose outer diameter is smaller than the outer diameter of the extension body. The outer sleeve of the rotating part is provided with a torsion spring, one end of the torsion spring is fixedly connected with the extension body, and the other end of the torsion spring is offset with the extension tube. One end of the rotating part is provided with a positioning member, and extends out of the extension pipe. said extension tube is provided with a pipe plug, one end of said pipe plug is provided with a follower, said positioning member is adapted to said follower.

As a further improvement of this Invention, said rope body extending out of said shell is set with a tie rod, and fixed connection with said tie rod.

As a further improvement of the Invention, the positioning member has an equilateral polygon cross-section.

As a further improvement of the Invention, the number of said follower members is the same as the number of the outer side of said positioning member.

As a further improvement of the Invention, the top of the said tie rod is embedded with a cylinder, and the said cylinder is provided with a soft spring between the said shell.

As a further improvement of the Invention, the elastic member is a coil spring.

As a further improvement of the Invention, said recess side wall is opened with a fixed slot, said elastic member of one end bent and embedded in said fixed slot, said shell is fixedly connected with a number of arc bar, said elastic member of the other end bent and fixed on said arc bar.

The beneficial effect of the Invention: The Invention realizes that the rope body drives the pipe plug to rotate, and the user pulls the rope body to drive the rising or falling of the curtain, and after each of them cooperates with any start-stop structure or spring winder that can be preloaded in advance, the curtain can be stopped at any position, and the function of automatic falling or rising can be realized. The part of the rope body extending out of the shell is equipped with a pulling rod, so that the rope body can be pulled by the pulling rod to facilitate the user's grip and prevent the rope body from knotting and other situations.

### BRIEF DESCRIPTION OF THE DRAWINGS

FIG. 1 is a schematic diagram of the three-dimensional structure of the Invention.

FIG. 2 is a schematic diagram of the structure at the screw in the Invention.

FIG. 3 is a schematic diagram of the structure at the extension tube in the Invention.

FIG. 4 is a schematic diagram of the structure at the recess in the Invention.

FIG. 5 is a schematic diagram of the structure at the column in the Invention.

FIG. 6 is a schematic diagram of the structure at the torsion spring in the Invention.

FIG. 7 is a schematic diagram of the structure at the rotating member in the Invention.

FIG. 8 is a schematic diagram of the structure at the roll-up bar in the Invention.

FIG. 9 is a schematic diagram of the structure of the pipe plug in the Invention.

FIG. 10 is a schematic diagram of the internal structure of the spring-loaded winder assembled in the Invention that can be preloaded in advance.

Attachment marks: 1—shell; 11—extension tube; 12—column; 13—curved bar; 2—disc; 21— extension body; 22—recess; 23—fixed slot; 3—elastic member; 4—rope body; 5—rotating member; 51—positioning member; 6—torsion spring; 7—pipe plug; 71—follower; 8—tie rod; 81— cylinder; 82—soft spring; 9—screw; 91—limit member; 911—limit body; 912—limit piece; 913— inset slot; 92—arc-shaped tab; 101—reducer; 12—self-locking device; 103—torsion spring providing rising force.

### DETAILED DESCRIPTION OF THE INVENTION

The following is a further detailed description of the Invention in conjunction with the accompanying drawings and examples. The same parts are indicated by the same symbols in the drawings. It should be noted that the words “front”, “back”, “left”, “right”, “up” and “down” used in the following description refer to the directions in the attached drawings. The terms “top” and “bottom” refer to the orientation in the attached drawings, and the terms “bottom” and “top”, “inside” and “bottom” refer to the orientation in the attached drawings. The terms “inside” and “outside” refer to the direction toward or away from the geometric center of a particular part, respectively.

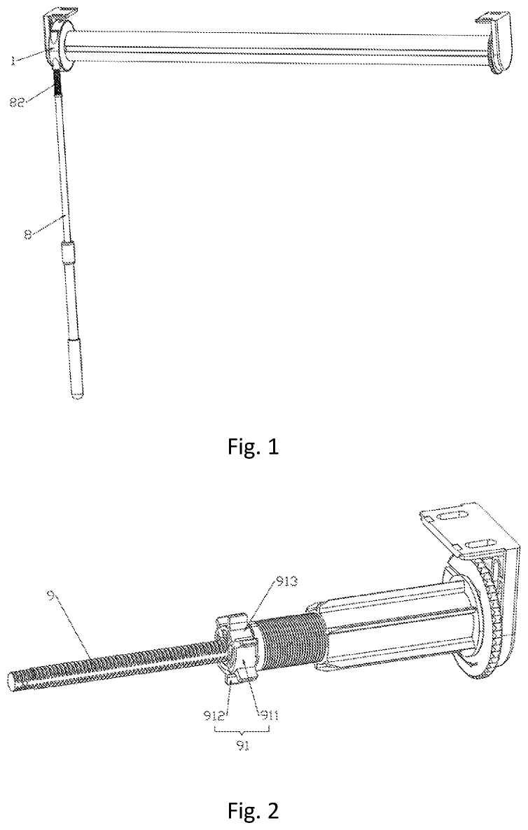

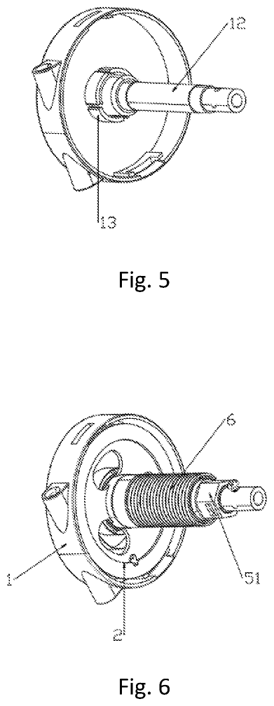

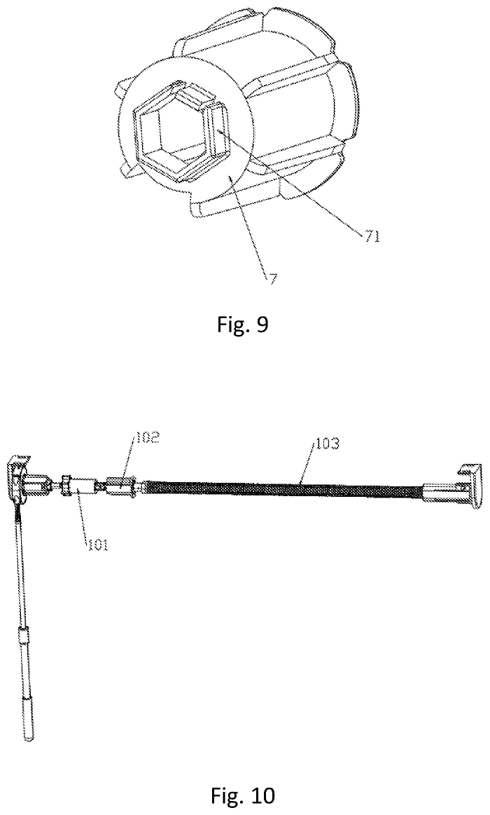

Referring to FIGS. 1 to 10, the automatic lowering or lifting roller shutter of this embodiment includes a shell 1, the shell 1 includes a first shell and a second shell detachably provided relative to the first shell. The first shell and the second shell are snap connected to each other, the first shell and the second shell are in a circular shape, used to adapt to the disc 2 and prevent interference with the disc 2 when the disc 2 is rotated. The first shell is used to connect with a fixed frame. The fixed frame is used to fix on the wall. The first shell and the second shell form a holding cavity between them, the disc 2 is located in the holding cavity, the shell 1 is provided with the disc 2. The shell 1 is provided with an extension tube 11 on one side, that is, the second shell is provided with an extension tube 11 on one side toward the rolling shutter rod, the disc 2 is provided with an extension body 21 on one side. At least part of the extension body 21 extends into the extension tube 11, so that the disc 2 is coaxial with the extension tube 11. The disc 2 is provided with a recess 22 on the side of the disc 2 back from the extension body 21, the elastic member 3 is provided in the recess 22, the elastic member 3 is coil spring. One end of said elastic member 3 being fixed to said disc 2 and the other end of said elastic member 3 being fixed to said shell 1. In the process of rotation of the disc 2, the elastic member 3 will undergo elastic deformation, that is means, in the process of pulling the rope body 4 downward by external force, the disc 2 will rotate. The direction of rotation can be changed according to the way the rope body 4 is wound on the disc 2, to limit whether the disc 2 is counterclockwise or clockwise. Different rotation direction, which determines whether the curtain is rising or falling, or the parts in the Invention are switched to the position installed on the fixed frame, left and right, the disc 2 is set around the peripheral direction of the rope body 4, one end of the rope body 4 is fixed with the disc 2, the other end of the rope body 4 extends out of the shell 1. The shell 1 is provided with a hole for the rope body 4 to pass through. The inner side of shell 1 is set with column 12, that is, the first shell towards the second shell of the inner surface of the integral molding of column 12, column 12 extends out of the extension tube 11, column 12 is rotating connected to the rotation member 5, the outer diameter of the rotation member 5 is smaller than the outer diameter of the extension body 21, the rotation member 5 is equipped with a torsion spring 6, one end of the torsion spring 6 is fixedly connected to the extension body 21, the other end of the torsion spring 6 is against the extension tube 11. One end of the rotating member 5 is provided with a positioning member 51, and extends out of the extension tube 11, the extension tube 11 is provided with a pipe plug 7, the shutter rod is set outside the pipe plug 7 and is connected to the pipe plug 7, one end of the pipe plug 7 is provided with a follower 71, the positioning member 51 is adapted to the follower 71.

When the rope body 4 is pulled downward, the rope body 4 drives the disc 2 to turn counterclockwise. At this time, the user's viewpoint is positive to the second shell, the roll spring undergoes elastic deformation, because the disc 2 turns. Due to the characteristics of the torsion spring 6, the outer diameter of the torsion spring 6 shrinks. The torsion spring 6 clamps the rotating part 5 and drives the rotating part 5 to rotate together. At this time, the torsion spring 6 slips against the end of the extension tube 11, so that the rotating member 5 can smoothly rotate. Because of the rotation of the rotating member 5, and through the positioning member 51 and the follower 71, making the pipe plug 7 rotation, the pipe plug 7 and thus drive the rotation of the shutter rod, the shutter achieves the rising function. After the external force to release the rope body 4, the force between the torsion spring 6 and the rotating member 5 will be release, it makes the shutter automatically down due to the gravity of the shutter. In this embodiment, any start stop structure is set to realize that the roller shutter can stop at any position. After loosening any start stop structure, the roller shutter automatically descends. After pulling rope body 4 downward, the roller shutter will rise for a distance. If there is no random start stop structure, the roller shutter will fall to the initial position after loosening rope body 4. Because of the arbitrary start-stop structure, the shutter will not drop and will stop. If the shutter is to be lowered, the rope body 4 will be pulled by a small amount to unlock the arbitrary start-stop structure. unlock the arbitrary start-stop structure, then the roll-up curtain automatically descends. After each pull of the rope body 4, relying on the return force of the roll-up spring to reset, the state between the torsion spring 6 and the rotation member 5 will be loosened during reset process.

When the rope body 4 is pulled downward, the rope body 4 drives the disc 2 to turn clockwise. At this time, the user's viewpoint is positive to the second shell, the roll spring undergoes elastic deformation, because the disc 2 turns. Due to the characteristics of the torsion spring 6, the outer diameter of the torsion spring 6 shrinks. The torsion spring 6 clamps the rotating part 5 and drives the rotating part 5 to rotate together. At this time, the torsion spring 6 slips against the end of the extension tube 11, so that the rotating member 5 can smoothly rotate. Because of the rotation of the rotating member 5, and through the positioning member 51 and the follower 71, making the pipe plug 7 rotation, the pipe plug 7 and thus drive the rotation of the shutter rod, the shutter achieves the descending function. In this embodiment, a spring-loaded shutter that can be preloaded in advance is set, so that the shutter can be stopped at any position, and the automatic ascending of the shutter is realized. Referring to FIG. 10, a reducer 101 is arranged from left to right to limit the rotation speed of the roller shutter rod, an self-locking device 102 is used to realize the random start and stop of the roller shutter, and a torsion spring 103 that provides the lifting force is used to provide an upward moving restoring force for the roller shutter.

Referring to FIG. 1, the part of the rope body 4 extending out of the shell 1 is provided with a tie rod 8, and fixed connection with the tie rod 8, through the tie rod 8 to pull the rope body 4, not only easy for the user to grip, but also to prevent the rope body 4 knot and other situations.

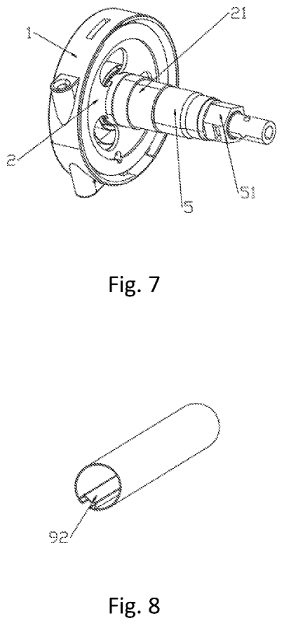

Referring to FIG. 7, the positioning member 51 has an equilateral polygon cross-section. The number of slave members 71 is the same as the number of outer sides of the positioning member 51, so that when the positioning member 51 is rotated, it can smoothly drive the slave members 71 to rotate and facilitate the installation between the pipe plug 7 and the rotating member 5.

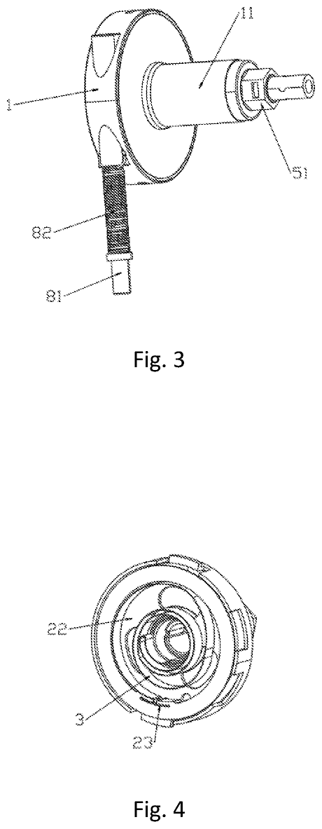

Referring to FIG. 3, the top of the lever 8 is embedded with a cylinder 81, and a soft spring 82 is provided between the cylinder 81 and the shell 1, so that the lever 8 can be shaken and the soft spring 82 can be deformed to change the user's pulling angle on the lever 8, preventing the soft spring 82 from breaking at the position when the user pulls the lever 8 and extending the service life of the lever 8.

Referring to FIG. 2, there is a screw 9 fixedly connected to the fixed frame opposite to the shell 1, and the screw 9 is threaded with a limit member 91, which is located in the rolling shutter rod and slidingly connected to the rolling shutter rod, during the rotation of the rolling shutter rod, the limit member 91 will rotate and move on the screw 9, and when the user releases any start-stop structure, the rolling shutter automatically descends, the limit member 91 also rotates. After rotating a certain distance, the limit member 91 will resist the end of the screw 9, limiting the rotation of the limit member 91, so that the shutter will stop after descending to a certain position, thus limiting the descending distance of the shutter.

Referring to FIG. 8, there is an arc-shaped tab 92 inside the roll-up bar along its length, the length of the top surface of the arc-shaped tab 92 is smaller than the length of the bottom surface, and the cross-section appears to be trapezoidal, and the limiting member 91 includes a limiting body 911 and a number of limit pieces 912. The limit piece 912 is uniformly provided along the circumference of the limit body 911 to form a number of inlay slots 913, and the arc-shaped tab 92 is embedded in one of the inlay slots 913 to facilitate the installation of the limit member 91.

The side wall of the recess 22 is provided with a fixed slot 23, and one end of the elastic member 3 is bent and embedded in the fixed slot 23. A number of arc bars 13 are fixedly connected inside the shell 1, and the other end of the elastic member 3 is bent and fixed to the arc bars 13, which is fixed by bending, without fixing by standard parts such as screws or welding, which facilitates the replacement and installation of the elastic member 3.

The above is only the preferred implementation of the Invention, and the scope of protection of the Invention is not limited to the above embodiments, all technical solutions belonging to the Invention idea belong to the scope of protection of the Invention. It should be pointed out that for a person of ordinary skill in the art, there are several improvements and embellishments without departing from the principle of the Invention, and these improvements and embellishments should also be regarded as the scope of protection of the Invention.

1. A automatic lowering or lifting roller shutter, comprising a shell, characterized in that: said shell is provided with a disc, said shell is provided with an extension tube on one side, said disc is provided with an extension body on one side, at least part of said extension body extends into said extension tube so that said disc is coaxial with said extension tube; a groove is arranged on the side of the disc away from the extension body, and an elastic element is arranged in the groove; one end of the elastic element is fixed with the disc, and the other end of the elastic element is fixed with the shell; the disc is surrounded by a rope body, one end of the rope body is fixed with the disc, and the other end of the rope body extends out of the shell; the inner side of the shell is provided with a cylinder, the cylinder extends out of the extension pipe, and the cylinder is rotationally connected with a rotating member whose outer diameter is smaller than the outer diameter of the extension body; the outer sleeve of the rotating part is provided with a torsion spring, one end of the torsion spring is fixedly connected with the extension body, and the other end of the torsion spring is offset with the extension tube; one end of the rotating part is provided with a positioning member, and extends out of the extension pipe; said extension tube is provided with a pipe plug, one end of said pipe plug is provided with a follower, said positioning member is adapted to said follower.

2. The automatic lowering or lifting roller shutter according to claim 1, wherein said rope body extending out of said shell is provided with a tie rod and is fixedly connected to said tie rod.

3. The automatic lowering or lifting roller shutter according to claim 2, wherein said positioning member has an equilateral polygonal cross-section.

4. The automatic lowering or lifting roller shutter according to claim 3, wherein the number of said slaves is the same as the number of the outer sides of said positioning members.

5. The automatic lowering or lifting roller shutter according to claim 1, wherein the top of said tie rod is embedded with a cylinder, and said cylinder is provided with a soft spring between said shell.

6. The automatic lowering or lifting roller shutter according to claim 1, wherein said elastic member is a coil spring.

7. The automatic lowering or lifting roller shutter according to claim 1, wherein said recess is provided with a fixing slot in the side wall, one end of said elastic member is bent and embedded in said fixing slot, a number of curved strips are fixedly connected in said shell, and the other end of said elastic member is bent and fixed to said curved strips.
